(19) United States
(12) Patent Application Publication
(10) Pub. No.: US 2026/0045377 A1
(43) Pub. Date: Feb. 12, 2026

(54) INTEGRATED REACTOR, AND CHARGING AND REFUELING SYSTEM AND METHOD

(71) Applicant: SHANGHAI NUCLEAR ENGINEERING RESEARCH & DESIGN INSTITUTE CO., LTD., Shanghai (CN)

(72) Inventors: Lei Li, Shanghai (CN); Xuefeng Zhu, Shanghai (CN); Mengzhi Li, Shanghai (CN); Changlei Shao, Shanghai (CN); Shaoxuan Lin, Shanghai (CN); Jianwen Liu, Shanghai (CN); Chenyang Weng, Shanghai (CN); Shangqing Huang, Shanghai (CN); Wei Wu, Shanghai (CN); Fei Mao, Shanghai (CN); Na Weng, Shanghai (CN); Chengwu Li, Shanghai (CN)

(21) Appl. No.: 19/101,186

(22) PCT Filed: Dec. 28, 2022
(86) PCT No.: PCT/CN2022/142739

§ 371 Date: Feb. 4, 2025

(30) Foreign Application Priority Data
Aug. 5, 2022 (CN) 202210939550.4

(51) Int. Cl. G21C 19/02; G21C 1/32

(52) U.S. Cl. CPC G21C 19/02; G21C 1/32

(57) ABSTRACT

An integrated reactor (100), and an integrated reactor charging and refueling system (1000) and a method. The integrated reactor (100) comprises: a reactor cavity (10); a containment (1), which is arranged in the reactor cavity (10), wherein the containment (10) comprises an upper containment (11) and a lower containment (12), and the upper containment (11) and the lower containment (12) are detachably and fixedly connected; and a pressure vessel (2), which is arranged in the containment (1), wherein the pressure vessel (2) comprises an upper pressure vessel (21) and a lower pressure vessel (22), the upper pressure vessel (21) and the lower pressure vessel (22) are detachably and fixedly connected, and the upper pressure vessel (21) and the upper containment (11) are fixedly connected to form an integrated hoisting structure (20).

### CROSS-REFERENCE TO RELATED APPLICATION

This application claims priority to Chinese Patent Application No. 202210939550.4, filed on Aug. 5, 2022 and entitled “Integrated reactor charging and refueling device, system and process”, which is incorporated herein by reference in its entirety.

### TECHNICAL FIELD

The present application relates to the technical field of reactors, and in particular to an integrated reactor, and a charging and refueling system and method.

### BACKGROUND

A reactor charging and refueling system is a system that systematically solves the problems of reactor body disassembly, core refueling, and fuel transfer and storage.

In the existing technology, for a charging and refueling system for compact pressurized water reactors, including integrated reactors, a method of sequentially opening the covers followed by in-reactor refueling is usually adopted, that is, a method of sequentially removing the top cover of the containment and the top cover of the reactor pressure vessel, sequentially hoisting out the control rod driving mechanism, the upper in-reactor components and the in-reactor measurement grid, and then sequentially replacing individual nuclear fuel assemblies in the reactor. When replacing a nuclear fuel assembly, first, a charging/discharging machine with a gantry crane structure is adopted to move above the reactor, the fuel gripper is lowered to the top of the nuclear fuel assembly, then a gripper mechanism provided on the gripper and a tube base structure on the nuclear fuel assembly are connected for grabbing and locking, and the gripper carrying the nuclear fuel assembly is lifted so that the fuel assembly is removed out of the core and transferred to the spent pool, thereby completing the removal operation of one fuel assembly. This process is cycled and the next nuclear fuel assembly is removed until all removals in the core are completed. The charging process of the core is the same as that in reverse order.

The existing refueling technology has the following main shortcomings.

Firstly, due to the method of sequentially opening the covers followed by in-reactor refueling, the steps of reactor disassembly and the steps of refueling cannot be carried out in parallel, thus the critical path for refueling is relatively long.

Secondly, for integrated reactors, due to the highly compact fully built-in layout, both the containment and the reactor pressure vessel have complex top penetrations, and there are compact built-in control rod driving mechanisms and heat exchange components inside the reactor, which greatly restricts the movement and expansion space of the sleeve of the charging/discharging machine in the reactor when adopting the traditional refueling technology, and brings great difficulty to the accessibility of in-reactor components.

Thirdly, for the integrated reactor, the space inside the reactor is compact and narrow when the cover is opened for refueling; furthermore, based on the need to establish natural circulation, the core depth is significantly increased compared to the pressurized water reactor with a forced circulation, and its core replacement operations will include operations on a “deep well type” ultra-deep core, which greatly restricts the in-reactor observation and capture necessary for traditional refueling technology to operate the fuel in the core.

Fourthly, the integrated reactor has the characteristics of a high degree of miniaturization and compactness, which facilitates the flexible use of modular layout in power plant layout, while the use of existing refueling technology requires more disassembly, storage locations and process space, which limits the advantages of the integrated reactor in the modular layout of the reactor.

### SUMMARY

In view of the above-mentioned problems existing in the related art, the purpose of the present invention is to provide an integrated reactor, and a charging and refueling system and method. By adopting integrated cover opening, overall core hoisting and out-of-reactor refueling, the present invention overcomes the difficulty and complexity of using traditional charging and refueling processes for integrated reactors with highly integrated structures in terms of reactor cover opening and deep-core fuel operation, thereby shortening the critical path for overhauling, and facilitating the modular arrangement of nuclear power plants with integrated reactors.

A first aspect of the present invention provides an integrated reactor, including: a reactor cavity; a containment arranged in the reactor cavity, wherein the containment includes an upper containment and a lower containment, and the upper containment and the lower containment are detachably and fixedly connected; and a pressure vessel arranged in the containment, wherein the pressure vessel includes an upper pressure vessel and a lower pressure vessel, the upper pressure vessel and the lower pressure vessel are detachably and fixedly connected, wherein the upper pressure vessel and the upper containment are fixedly connected to form an integrated hoisting structure.

Preferably, the pressure vessel is provided with reactor internals therein, and the reactor internals include a control rod driving mechanism, an upper in-reactor component, an in-reactor measurement grid, and a reactor core provided with a nuclear fuel assembly therein, wherein the reactor core is arranged in the lower pressure vessel and is provided with a reactor core hoisting structure for hoisting the reactor core; and the in-reactor measurement grid is connected to the upper in-reactor component, the upper in-reactor component is connected to the control rod driving mechanism, and the control rod driving mechanism and the upper in-reactor component are connected into one piece with the upper pressure vessel.

Preferably, an out-of-reactor guide device is provided outside the containment, and the out-of-reactor guide device is configured to provide hoisting guidance for the reactor core passing a position of the upper pressure vessel when the reactor core is hoisted.

Preferably, an in-reactor guide device is provided in the lower pressure vessel, and the in-reactor guide device is configured to provide hoisting guidance for the reactor core in the lower pressure vessel when the reactor core is hoisted.

A second aspect of the present invention provides an integrated reactor charging and refueling system, wherein the system includes a reactor core hoisting tool and the integrated reactor according to the first aspect of the present invention, and during charging and refueling of the integrated reactor, after the integrated hoisting structure is hoisted and removed as a whole, the reactor core hoisting tool is able to enter the interior of the lower pressure vessel to be connected with the reactor core hoisting structure, so as to hoist and remove the reactor core as a whole.

Preferably, the reactor core hoisting tool has a first guide part, and the first guide part is configured to cooperate with the out-of-reactor guide device for guiding the movement of the reactor core hoisting tool at the position of the upper pressure vessel.

Preferably, the reactor core hoisting tool has a second guide part, and the second guide part is configured to cooperate with the in-reactor guide device for guiding the movement of the reactor core hoisting tool in the lower pressure vessel.

Preferably, the integrated reactor charging and refueling system according to the present invention further includes a reactor core storage rack, a refueling machine, a spent fuel pool and a refueling pool, wherein the reactor core storage rack is located in the refueling pool, the reactor core hoisted out of the lower pressure vessel by the reactor core hoisting tool is to be arranged in the reactor core storage rack, and the refueling machine is configured to take the nuclear fuel assembly out of the reactor core to the spent fuel pool for refueling.

Preferably, the integrated reactor charging and refueling system according to the present invention further includes a reactor cavity water gate for isolating the reactor cavity from the refueling pool, and for controlling a refueling water level in the reactor cavity.

Preferably, the integrated reactor charging and refueling system according to the present invention further includes a spent pool water gate for isolating the refueling pool from the spent fuel pool.

Preferably, the integrated reactor charging and refueling system according to the present invention further includes an integrated hoisting structure storage rack disposed in the refueling pool for placing the removed integrated hoisting structure.

A third aspect of the present invention provides an integrated reactor charging and a refueling method, which is implemented by using the integrated reactor charging and refueling system according to the second aspect of the present invention, wherein the method includes the following steps of: hoisting and removing the integrated hoisting structure as a whole; moving the reactor core hoisting tool above the integrated reactor; enabling the first guide part of the reactor core hoisting tool to cooperate with the out-of-reactor guide device to guide slow lowering of the reactor core hoisting tool at the position of the upper pressure vessel; enabling the second guide part of the reactor core hoisting tool to cooperate with the in-reactor guide device to guide slow lowering of the reactor core hoisting tool at a position of the lower pressure vessel; connecting the reactor core hoisting tool with the reactor core hoisting structure; enabling the reactor core hoisting tool to drive the reactor core to move out of the integrated reactor; and refueling the nuclear fuel assembly in the reactor core by using the refueling machine.

In the integrated reactor and the charging and refueling system and method of the present invention, an integrated hoisting structure is adopted, which can realize integrated cover opening, thereby greatly simplifying the complex disassembly and assembly of the penetrations on the top of the integrated reactor and the tedious disassembly process of reactor components, reducing the difficulty of refueling, shortening the critical path for refueling and overhaul, and improving the economics of operation and maintenance of power plants.

Due to the simplified and optimized system structure brought about by the integrated cover opening, overall reactor core hoisting and out-of-reactor refueling, it is beneficial to modularize the arrangement of compact reactors such as integrated reactors, which facilitates the realization of overall arrangements of single reactors, dual reactors or multiple reactors, and improves the technical flexibility of integrated reactors in site applications. By adopting the overall reactor core hoisting and out-of-reactor refueling, compared with the existing pressurized water reactor refueling technology, the operation on fuel assemblies can be separated from the critical path for refueling and can be carried out simultaneously with the further disassembly of the reactor, thereby shortening the overhaul path and improving the economics of operation and maintenance of power plants.

It should be understood that the above general description and the following detailed description are exemplary only and do not limit the present application.

### BRIEF DESCRIPTION OF THE DRAWINGS

In order to illustrate the technical solutions of the embodiments of the present application more clearly, the accompanying drawings to be used in the embodiments of the present application will be briefly introduced below. Apparently, the accompanying drawings described below are only the specific embodiments of the present application, and those skilled in the art can obtain other embodiments according to the following accompanying drawings without making creative efforts.

FIG. 1 is a schematic diagram of an integrated reactor according to a specific embodiment of the present invention;

FIG. 2 is a schematic diagram of an integrated hoisting structure according to a specific embodiment of the present invention;

FIG. 3 is a schematic diagram of a reactor core according to a specific embodiment of the present invention;

FIG. 4 is a schematic diagram of an in-reactor guide device installed in the lower pressure vessel according to a specific embodiment of the present invention;

FIG. 5 is a schematic diagram of an integrated reactor charging and refueling system according to a specific embodiment of the present invention;

FIG. 6 is a schematic diagram of a reactor core hoisting tool according to a specific embodiment of the present invention;

FIG. 7 is a top view of an integrated reactor charging and refueling system according to a specific embodiment of the present invention;

FIG. 8 is a flow chart of an integrated reactor charging and refueling method according to a specific embodiment of the present invention;

FIG. 9 is a schematic diagram of hoisting the integrated hoisting structure as a whole to the integrated hoisting structure storage rack according to a specific embodiment of the present invention;

FIG. 10 is a schematic diagram of lowering of the reactor core hoisting tool cooperating with the guide device according to a specific embodiment of the present invention;

FIG. 11 is a schematic diagram of the connection between the connection structure of the reactor core hoisting tool and the reactor core hoisting structure according to a specific embodiment of the present invention;

FIG. 12 is a schematic diagram of hoisting out the reactor core and placing the reactor core on the reactor core storage rack by the reactor core hoisting tool according to a specific embodiment of the present invention; and

FIG. 13 is a schematic diagram of refueling nuclear fuel assemblies by the refueling machine according to a specific embodiment of the present invention.

### REFERENCE SIGNS

1000—Integrated reactor charging and refueling system;
100—Integrated reactor;
10—Reactor cavity;
20—Integrated hoisting structure;
1—Containment;
11—Upper containment;
12—Lower containment;
13—First refueling flange;
14—Inspection flange;
2—Pressure vessel;
21—Upper pressure vessel;
22—Lower pressure vessel;
23—Second refueling flange;
3—Reactor internals;

31—Control rod driving mechanism;
32—Upper in-reactor components;
33—In-reactor measurement grid;
34—Reactor core;
341—Reactor core hoisting structure;
35—Lower in-reactor components;
4—Out-of-reactor guide device;
5—In-reactor guide device;
200—Reactor core hoisting tool;
201—First guide part;
202—Second guide part;
203—Operating platform;
300—Reactor core storage rack;
400—Refueling machine;
401—Bridge crane;
402—Telescopic sleeve;
403—Special operating gripper;
500—Spent fuel pool;
510—Spent fuel storage grid rack;
600—Refueling pool;
700—Reactor cavity water gate;
800—Spent fuel pool;
900—Integrated hoisting structure storage rack;
1100—Lifting apparatus;
1200—Lower in-reactor component storage rack.

The accompanying drawings, which are incorporated in and constitute a part of the present description, illustrate embodiments consistent with the present application and serve, together with the description to explain the principles of the present application.

### DETAILED DESCRIPTION

In order to better understand the technical solutions of the present application, the embodiments of the present application will be described in detail below in conjunction with the accompanying drawings.

It should be understood that the described embodiments are only some of the embodiments of the present application, rather than all of them. Based on the embodiments in this application, all other embodiments obtained by a person skilled in the art without paying creative effort fall within the protection scope of this application.

The terms used in the embodiments of the present application are only for the purpose of describing specific embodiments, and are not intended to limit the present application. The singular forms “a”, “an”, “said” and “the” used in the embodiments of the present application and the appended claims are also intended to include plural forms unless the context clearly indicates otherwise.

It should be understood that the term “and/or” as used herein is only a kind of associative relationship describing associated objects, which means that there can be three kinds of relationships, for example, A and/or B can represent three cases as follows: there is A alone; there are A and B at the same time; and there is B alone. In addition, the character “/” herein generally indicates that the associated objects before and after “/” are in an “or” relationship.

It should be noted that the orientation words such as “up”, “down”, “left” and “right” described in the embodiments of the present application are described with the angle shown in the accompanying drawings, and should not be understood as limitations on the embodiments of this application. Furthermore, in this context, it also needs to be understood that when it is mentioned that one element is connected “on” or “under” another element, the one element can not only be directly connected “on” or “under” said another element, but can also be indirectly connected “on” or “under” said another element through an intermediate element.

After the nuclear fuel of a nuclear power reactor reaches the end of its life, the fuel must be replaced timely, and in-service inspections and necessary repairs or replacements must be conducted on in-reactor components, reactor pressure vessels, main bolts and other components. The entire process must ensure safety to prevent the occurrence of unexpected criticality.

The present invention provides an integrated reactor, and an integrated reactor charging and refueling system and method, which, by adopting integrated cover opening, overall core hoisting and out-of-reactor refueling, overcomes the difficulty and complexity of using traditional charging and refueling processes for integrated reactors with highly integrated structures in terms of reactor cover opening and deep-core fuel operation, thereby shortening the critical path for overhauling, and facilitating the modular arrangement of nuclear power plants with integrated reactors.

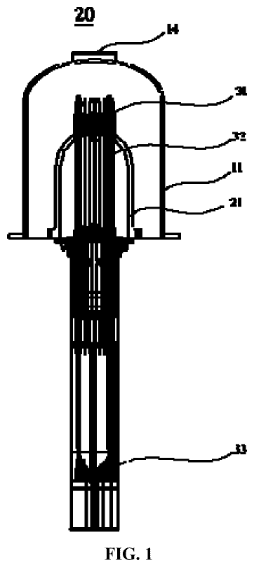

FIG. 1 is a schematic diagram of an integrated reactor 100 according to a specific embodiment of the present invention.

As shown in FIG. 1, the integrated reactor 100 according to the specific embodiment of the present invention includes: a reactor cavity 10, a containment 1 disposed in the reactor cavity 10, and a pressure vessel 2 disposed in the containment 1.

The containment 1 includes an upper containment 11 and a lower containment 12. The upper containment 11 and the lower containment 12 are detachably and fixedly connected. In a specific embodiment, the upper containment 11 and the lower containment 12 are connected through a first refueling flange 13. By opening the first refueling flange 13, the upper containment 11 and the lower containment 12 can be separated.

An inspection flange 14 is provided on the upper containment 11. When it is necessary to inspect the interior of the integrated reactor 100 or refuel the reactor core, the inspection flange 14 can be opened to operate the interior of the integrated reactor 100.

By providing the inspection flange 14 and the first refueling flange 13, the containment 1 forms a two-stage top opening structure, that is, the inspection flange 14 on the top of the containment 1 is first disassembled to realize the first-stage top opening of the containment, and then the first refueling flange 13 of the containment 1 is disassembled to realize the second-stage top opening of the containment 1.

Referring to FIG. 1, the pressure vessel 2 is disposed in the containment 1. The pressure vessel 2 includes an upper pressure vessel 21 and a lower pressure vessel 22, and the upper pressure vessel 21 and the lower pressure vessel 22 are detachably and fixedly connected. In a specific embodiment, the upper pressure vessel 21 and the lower pressure vessel 22 are connected through a second refueling flange 23. By opening the second refueling flange 23, the upper pressure vessel 21 and the lower pressure vessel 22 can be separated.

When the interior of the integrated reactor 100 is inspected or the reactor core is refueled, the inspection flange 14 of the containment 1 may be opened first, and the second refueling flange 23 of the pressure vessel 2 is disassembled inside the containment 1 through the inspection flange 14, so as to separate the upper pressure vessel 21 and the lower pressure vessel 22.

In a specific embodiment, the upper pressure vessel 21 is fixedly connected to the upper containment 11 to form the integrated hoisting structure 20. The upper pressure vessel 21 and the upper containment 11 may be connected into one piece by a pre-fixed internal connecting rod structure (not shown), or may be connected through other connecting structures, which is not specifically limited in this application.

After the second refueling flange 23 of the pressure vessel 2 is disassembled by entering the interior of the containment 1 through the inspection flange 14, the first refueling flange 13 of the containment 1 is disassembled to separate the upper containment 11 from the lower containment 12. Since the upper pressure vessel 21 and the upper containment 11 are connected into one piece and form an integrated hoisting structure 20, the upper pressure vessel 21 and the upper containment 11 of the integrated hoisting structure 20 can be hoisted as a whole when refueling the core, so as to achieve one-time hoisting.

Through the provision of the two-stage top opening and the integrated hoisting structure, the integrated cover opening of the reactor 100 is realized, thereby greatly simplifying the complex disassembly and assembly of the penetrations on the top of the integrated reactor 100 and the tedious disassembly process of reactor components, reducing the difficulty of refueling, shortening the critical path for refueling and overhauling, and improving the economics of operation and maintenance of power plants.

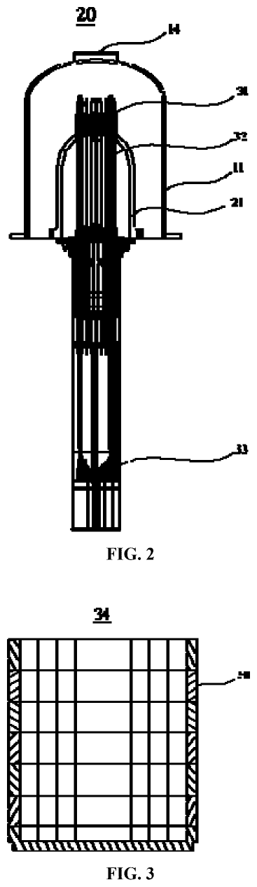

FIG. 2 is a schematic diagram of the integrated hoisting structure 20 according to a specific embodiment of the present invention.

Referring to FIG. 1 and FIG. 2, the interior of the pressure vessel 2 is provided with reactor internals 3, including a control rod driving mechanism 31, an upper in-reactor component 32, an in-reactor measurement grid 33, a reactor core 34 provided with nuclear fuel assemblies (not shown) therein, and a lower in-reactor component.

In a specific embodiment, the in-reactor measurement grid 33 is connected to the upper in-reactor component 32, the upper in-reactor component 32 is connected to the control rod driving mechanism 31, and the control rod driving mechanism 31 and the upper in-reactor component 32 are connected into one piece with the upper pressure vessel 21, so as to form the integrated hoisting structure 20 together with the upper containment 11.

When refueling the reactor core 34, the inspection flange 14 of the containment 1 is first opened, and then the second refueling flange 23 of the pressure vessel 2 is disassembled by entering the containment 1 through the inspection flange 14, so as to separate the upper pressure vessel 21 and the lower pressure vessel 22. The following operations are continually performed in the containment 1 through the inspection flange 14: the control rod driving mechanism 31 is released, and the in-reactor measurement grid 33 is lifted, so that the upper pressure vessel 21 is completely separated from the lower pressure vessel 22. Then the first refueling flange 13 of the containment 1 is disassembled to separate the upper containment 11 from the lower containment 12. Since the upper pressure vessel 21 and the upper containment 11 are connected into one piece, the control rod driving mechanism 31, the upper in-reactor component 32, and the in-reactor measurement grid 33, which are connected on the upper pressure vessel 21 and the upper containment 11 together form the integrated hoisting structure 20.

When to refuel the reactor core 34, the integrated hoisting structure 20 is hoisted as a whole to realize the one-time hoisting and removing of all of the control rod driving mechanism 31, the upper in-reactor component 32, the in-reactor measurement grid 33, the upper pressure vessel 21 and the upper containment 11. At this time, the reactor core 34 may be directly operated, and the entire core 34 may be hoisted out of the reactor as a whole for refueling operations.

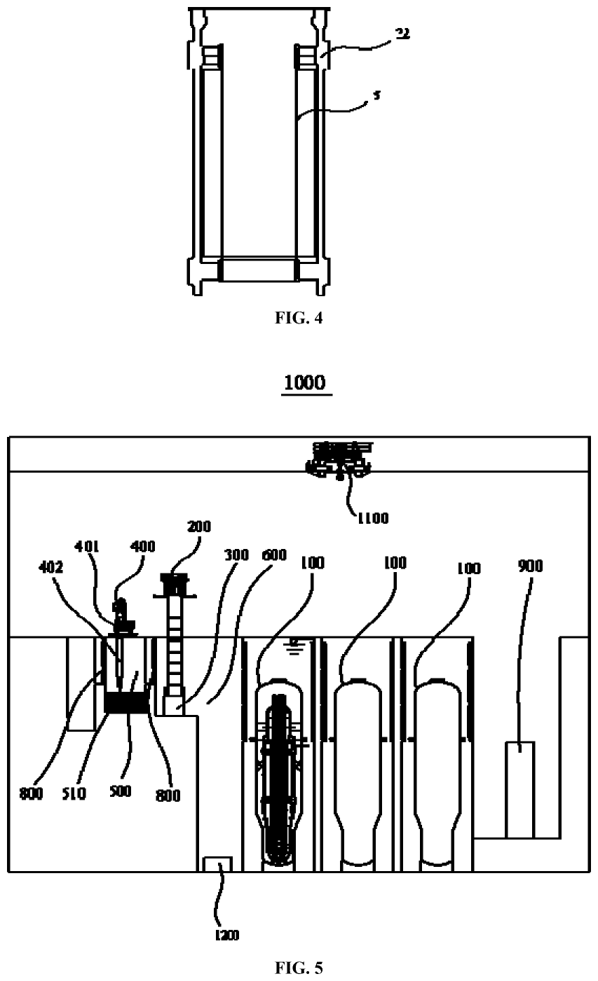

FIG. 3 is a schematic diagram of the reactor core 34 according to a specific embodiment of the present invention.

As shown in FIGS. 1 and 3, the reactor core 34 is arranged in the lower pressure vessel 22, and is provided with a reactor core hoisting structure 341 for hoisting the reactor core 34. The reactor core hoisting structure 341 includes a structure for supporting the reactor core 34 and performing overall hoisting, and is provided with a hoisting interface (not shown) which is able to be connected to an external hoisting tool.

The core hoisting structure 341 is arranged at a deep core position of the lower pressure vessel 22. When to refuel the reactor core 34, the reactor core hoisting structure 341 can be separated from the lower in-reactor component 35 and can carry all of components of the reactor core 34 for hoisting the reactor core 34 as a whole to achieve overall hoisting and overall storage.

Compared with the existing pressurized water reactor refueling technology, by adopting the overall hoisting of the reactor core 34 and the external refueling, the operation on nuclear fuel assemblies can be separated from the critical path for refueling and can be carried out simultaneously with the further disassembly of the reactor, thereby shortening the overhaul path and improving the economics of operation and maintenance of power plants. In addition, due to the simplified and optimized system structure brought about by the integrated cover opening, overall hoisting of the reactor core 34 and out-of-reactor refueling, it is beneficial to modularize the arrangement of compact reactors such as the integrated reactor 100, which facilitates the realization of overall arrangements of single reactors, dual reactors or multiple reactors, and improves the technical flexibility of the integrated reactor 100 in site applications.

Referring further to FIG. 1, an out-of-reactor guide device 4 is provided outside the containment 1. During the hoisting of the reactor core 34, the out-of-reactor guide device 4 provides a hoisting guidance for the reactor core 34 as it passes the position of the upper pressure vessel 21.

The out-of-reactor guide device 4 can be installed on the upper part of the inner wall of the reactor cavity 10 and can extend to the first refueling flange 13 of the containment 1. After the integrated hoisting structure 20 is removed, the out-of-reactor guide device 4 can cooperate with an external hoisting tool to provide guidance for the centering between the external hoisting tool and the reactor core hoisting structure 341 above the first refueling flange 13.

FIG. 4 is a schematic diagram of an in-reactor guide device 5 installed in the lower pressure vessel 22 according to a specific embodiment of the present invention. For convenience of illustration, only a part of the lower pressure vessel 22 is shown in FIG. 4.

As shown in FIG. 4, the in-reactor guide device 5 is provided in the lower pressure vessel 22. When hoisting the reactor core 34, the in-reactor guide device 5 provides a hoisting guidance for the reactor core 34 in the lower pressure vessel 22.

When the external hoisting tool is lowered to the position of the lower pressure vessel 22 by cooperating with the out-of-reactor guide device 4, the in-reactor guide device 5 may cooperate with the external hoisting tool to guide the movement of the external hoisting tool in the lower pressure vessel 22 until the external hoisting tool reaches the position of the reactor core 34 and is connected to the reactor core hoisting structure 341, so as to hoist the reactor core 34 out.

By adopting the two-stage guide structure composed of the out-of-reactor guide device 4 and the in-reactor guide device 5, the difficulties in operating and observing nuclear fuel assemblies in the “deep well type” ultra-deep core of the integrated reactor 100 can be avoided, and the centering problems in operations on the deep core of the integrated reactor 100 can be solved.

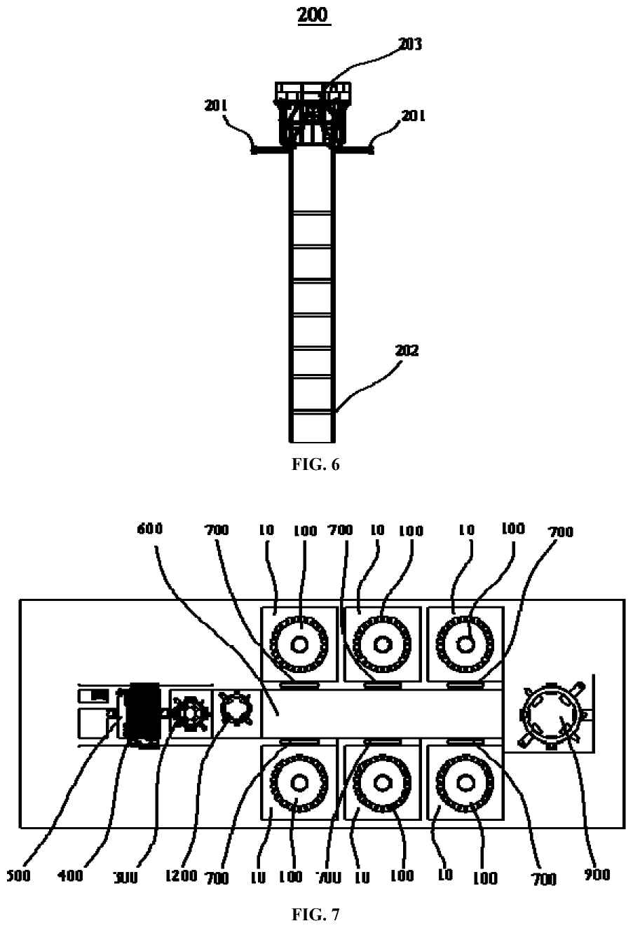

FIG. 5 is a schematic diagram of an integrated reactor charging and refueling system 1000 according to a specific embodiment of the present invention.

As shown in FIG. 5, the integrated reactor charging and refueling system 1000 according to the specific embodiment of the present invention includes a reactor core hoisting tool 200 and an integrated reactor 100. FIG. 5 shows that the nuclear power plant is modularly provided with multiple integrated reactors 100, and the reactor core hoisting tool 200 can operate these integrated reactors 100 to hoist the reactor cores 34 out of the lower pressure vessels 22. In order to clearly illustrate the present invention, one of the integrated reactors 100 shows its internal structure and the others do not show internal structures.

During the refueling of the integrated reactor 100, after the integrated hoisting structure 20 is hoisted and removed as a whole, the reactor core hoisting tool 200 can enter the interior of the lower pressure vessel 22 to be connected to the reactor core hoisting structure 341, so as to hoist out the reactor core 34 as a whole.

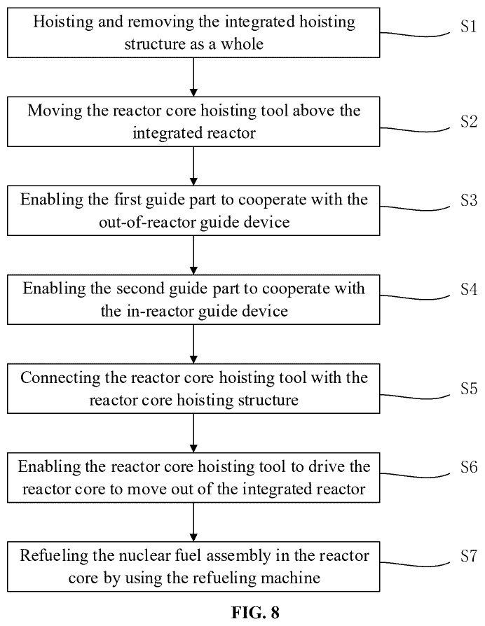

FIG. 6 is a schematic diagram of the reactor core hoisting tool 200 according to a specific embodiment of the present invention.

As shown in FIG. 6, the reactor core hoisting tool 200 is provided with a first guide part 201. The first guide part 201 cooperates with the out-of-reactor guide device 4 to guide the movement of the reactor core hoisting tool 200 at the position of the upper pressure vessel 21.

In a specific embodiment, the reactor core hoisting tool 200 is provided with a second guide part 202. The second guide part 202 cooperates with the in-reactor guide device 5 to guide the movement of the reactor core hoisting tool 200 in the lower pressure vessel 22.

The lower end of the reactor core hoisting tool 200 is provided with a connection structure (not shown) that can be connected to the reactor core hoisting structure 341. The connection structure may be a mechanical connection structure such as a snap connection, so that the reactor core hoisting tool 200 can hoist out the core hoisting structure 341. The reactor core hoisting tool 200 is further provided with an operating platform 203, on which the reactor core hoisting tool 200 can be operated, so that the first guide part 201 cooperates with the out-of-reactor guide device 4, the second guide part 202 cooperates with the in-reactor guide device 5, and the connection structure of the reactor core hoisting tool 200 can be fixedly connected to the reactor core hoisting structure 341.

Referring further to FIGS. 5 and 6, a lifting apparatus 1100 is provided above the operation hall of the integrated reactor 100. The lifting apparatus 1100 has a heavy-load double-beam bridge crane with high positioning accuracy and is used to hoist heavy-load items during refueling of the reactor 100. When the reactor core 34 needs to be refueled, the integrated hoisting structure 20 of the integrated reactor 100 is hoisted and removed as a whole by the lifting apparatus 1100; then the lifting apparatus 1100 is used to hoist the reactor core hoisting tool 200 and move it above the integrated reactor 100, and slowly lower the reactor core hoisting tool 200 so that the first guide part 201 of the reactor core hoisting tool 200 with the out-of-reactor guide device 4 and the out-of-reactor guide device 4 provides guidance for the centering between the reactor core hoisting tool 200 and the reactor core hoisting structure 341 at a position above the first refueling flange 13. When the reactor core hoisting tool 200 is lowered to the position of the lower pressure vessel 22 by cooperating with the out-of-reactor guide device 4, the second guide part 202 cooperates with the in-reactor guide device 5 to guide the movement of the reactor core hoisting tool 200 in the lower pressure vessel 22 until the reactor core hoisting tool 200 reaches the position of the reactor core 34, so that the connection structure of the reactor core hoisting tool 200 is connected to the reactor core hoisting structure 341 for hoisting out the reactor core 34.

During the process of guiding the reactor core hoisting tool 200 in the reactor, the refueling water level is always maintained slightly higher than the second refueling flange 23 but lower than the operating platform 203 of the reactor core hoisting tool 200. After all of the two stages of reactor core guidance is completed, the overall structure of the reactor core 34 is lifted out of the integrated reactor 100, and at this time, the refueling water level also returns to the high normal water level.

Due to adopting the overall hoisting of the reactor core 34 and the cooperating of the reactor core guide device with a two-stage guide structure, the lowering of the refueling water level in the reactor cavity 34 is accompanied below the reactor core hoisting tool 200, and the design height of the reactor core hoisting tool 200 may be significantly shortened, thereby significantly reducing the process height of the operation and maintenance factory and improving the construction economics of the integrated reactor 100.

Referring further to FIG. 5, the integrated reactor charging and refueling system 1000 of the present invention further includes a reactor core storage rack 300, a refueling machine 400, a spent fuel pool 500 and a refueling pool 600. The reactor core storage rack 300 is located in the refueling pool 600, and the reactor core 34 hoisted by the reactor core hoisting tool 200 out of the lower pressure vessel 22 is placed in the reactor core storage rack 300. The refueling machine 400 takes the nuclear fuel assemblies out of the reactor core 34 to the spent fuel pool 500 for refueling.

The spent fuel pool 500 is used for spent fuel storage and inserts replacement. A spent fuel storage grid rack 510, which has a frame structure composed of multiple rows and columns of dedicated nuclear fuel assembly storage chambers, is provided in the spent fuel pool 500, and is used to store nuclear fuel assemblies discharged from the reactor core 34 and nuclear fuel assemblies to be charged into the reactor core 34.

The reactor core storage rack 300 is used to store the reactor core hoisting structure 341 removed from the reactor 100 in the refueling pool 600, and supports the refueling machine 400 to perform an operation on a single nuclear fuel assembly here. The reactor core storage rack 300 is provided with a support ring and a guide pin, which can fix the reactor core hoisting structure 341 on the reactor core storage rack 300.

The refueling machine 400 is an integrated refueling machine, which has a bridge crane 401 that can move above the spent fuel pool 500. The bridge crane 401 is connected with a telescopic sleeve 402, and a special operating gripper 403 (see FIG. 13) is provided at the end of the telescopic sleeve 402 for lifting nuclear fuel assemblies and inserts.

FIG. 7 is a top view of the integrated reactor charging and refueling system 1000 according to a specific embodiment of the present invention.

As shown in FIG. 7, the integrated reactor charging and refueling system of the present invention further includes a reactor cavity water gate 700 for isolating the reactor cavity 10 from the refueling pool 600, and for controlling the refueling water level in the reactor cavity 10.

FIG. 7 shows that the nuclear power plant is modularly provided with six integrated reactors 100, and the reactor cavity water gate 700 is provided on the side wall of each reactor cavity 10 connected to the refueling pool 600. The reactor cavity water gate 700 has a restart sealing ring for ensuring the sealing between the reactor cavity 10 and the refueling pool 600. In addition, the reactor cavity water gate 700 has a movable switch actuator (not shown) to realize automatic opening and closing of the reactor cavity water gate 700, thereby accurately controlling the refueling water level in the reactor cavity 10.

Referring further to FIG. 5, the integrated reactor charging and refueling system 1000 of the present invention further includes a spent pool water gate 800 for isolating the refueling pool 600 from the spent fuel pool 500.

The spent pool water gate 800 has a restart sealing ring for ensuring the sealing between the spent fuel pool 800 and the refueling pool 600. The spent pool water gate 800 has a flat-opening switch actuator (not shown) to realize automatic opening and closing of the spent pool water gate 800.

The integrated reactor charging and refueling system 1000 of the present invention further includes an integrated hoisting structure storage rack 900, which is provided in the refueling pool 600 for placing the disassembled integrated hoisting structure 20. The integrated hoisting structure storage rack 900 is provided with a support ring and a guide pin, so that the integrated hoisting structure 20 can be fixed on the integrated hoisting structure storage rack 900.

In the lower part of the refueling pool 600, a lower in-reactor component storage rack 1200 is further provided. The lower in-reactor component storage rack 1200 is a special storage rack structure with a support ring and a guide pin, and is used to store the lower in-reactor component 35 in the refueling pool 600 after the reactor core hoisting structure 341 has been removed.

In the integrated reactor charging and refueling system 1000 of the present invention, due to the simplified and optimized system structure brought about by the integrated cover opening, overall hoisting of the reactor core 34 and out-of-reactor refueling adopted by the reactor 100, it is beneficial to modularize the arrangement of compact reactors such as the integrated reactor 100, which facilitates the realization of overall arrangements of single reactors, dual reactors or multiple reactors, and improves the technical flexibility of the integrated reactor 100 in site applications.

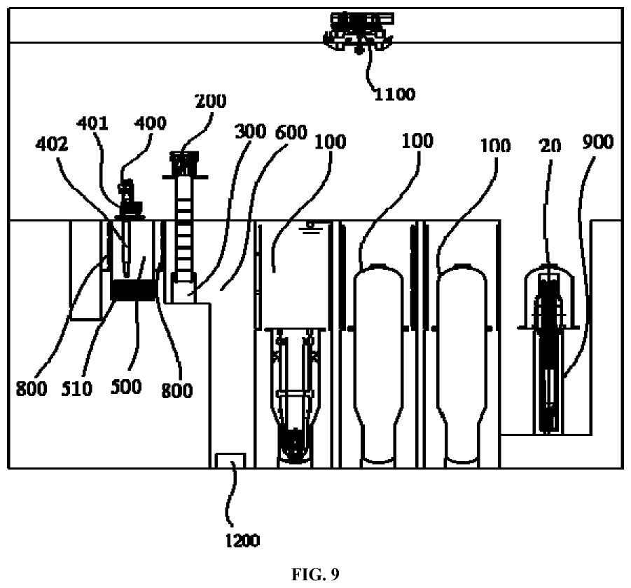

FIG. 8 is a flowchart of the integrated reactor charging and refueling method according to a specific embodiment of the present invention.

As shown in FIG. 8, the integrated reactor charging and refueling method according to the specific embodiment of the present invention is implemented by using the integrated reactor charging and refueling system 1000, and includes the following steps:
Step S1: the integrated hoisting structure is hoisted and removed as a whole;
Step S2: the reactor core hoisting tool is moved above the integrated reactor;
Step S3: the first guide part of the reactor core hoisting tool is enabled to cooperate with the out-of-reactor guide device to guide the slow lowering of the reactor core hoisting tool at the position of the upper pressure vessel;
Step S4: the second guide part of the reactor core hoisting tool is enabled to cooperate with the in-reactor guide device to guide the slow lowering of the reactor core hoisting tool at the position of the lower pressure vessel;
Step S5: the reactor core hoisting tool is connected to the reactor core hoisting structure;
Step S6: the reactor core hoisting tool is enabled to drive the reactor core to move out of the integrated reactor; and
Step S7: the nuclear fuel assemblies in the reactor core are refueled by the refueling machine.

FIG. 9 is a schematic diagram of hoisting the integrated hoisting structure 20 as a whole to the integrated hoisting structure storage rack 900 according to a specific embodiment of the present invention.

As shown in FIG. 9, in step S1, preparation before opening the top of the integrated reactor 100 is first performed. Specifically, the top penetrations on the top of the reactor 100 is removed, the inspection flange 14 of the containment 1 is opened, and then the second refueling flange 23 of the pressure vessel 2 is disassembled by entering the containment 1 through the inspection flange 14, so that the upper pressure vessel 21 is separated from the lower pressure vessel 22. The following operations are continually performed in the containment 1 through the inspection flange 14: the control rod driving mechanism 31 is released, and the in-reactor measurement grid 33 is lifted, so that the upper pressure vessel 21 is completely separated from the lower pressure vessel 22. Then the first refueling flange 13 of the containment 1 is disassembled, so that the upper containment 11 is separated from the lower containment 12. In this way, the integrated hoisting structure 20 is completely disassembled from the integrated reactor 100.

Then the lifting apparatus 1100 is used to slowly lift the integrated hoisting structure 20 as a whole, move it above the integrated hoisting structure storage rack 900, and then slowly place and fix it on the integrated hoisting structure storage rack 900. Subsequent on-site operations such as disassembly inspection can be carried out simultaneously.

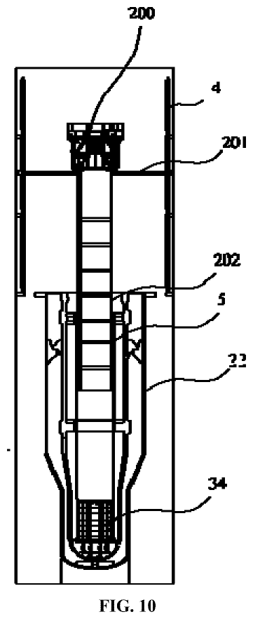

FIG. 10 is a schematic diagram of lowering of the reactor core hoisting tool 200 cooperating with the guide device according to a specific embodiment of the present invention.

As shown in FIG. 10, in step S2, the lifting apparatus 1100 is used to move the reactor core hoisting tool 200 above the integrated reactor 100 to center them, and then the reactor core hoisting tool 200 is slowly lowered.

In step S3, the first guide part 201 of the reactor core hoisting tool 200 is enabled to cooperate with the out-of-reactor guide device 4 to guide slow lowering of the reactor core hoisting tool 200 at the position of the upper pressure vessel 21.

While the reactor core hoisting tool 200 is being lowered, the reactor cavity water gate 700 is opened, so that the refueling water level in the reactor cavity 10 is synchronously lowered until it is close to the position of the second refueling flange 23 of the pressure vessel 2. In this process, the water level is always maintained slightly lower than the operating platform 203 of the reactor core hoisting tool 200.

In step S4, the second guide part 202 of the reactor core hoisting tool 200 is enabled to cooperate with the in-reactor guide device 5 to guide slow lowering of the reactor core hoisting tool 200 at the position of the lower pressure vessel 22; and the refueling water level in the reactor cavity 10 is always maintained slightly higher than the second refueling flange 23, but lower than the operating platform of the reactor core hoisting tool 200.

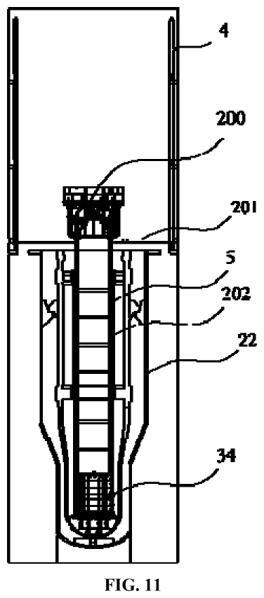

FIG. 11 is a schematic diagram of the connection between the connection structure of the reactor core hoisting tool 200 and the reactor core hoisting structure 341 according to a specific embodiment of the present invention.

As shown in FIG. 11, in step S5, after the centering between the reactor core hoisting tool 200 and the reactor core hoisting structure 341 is completed, the connection between the reactor core hoisting tool 200 and the reactor core hoisting structure 341 is realized by a remote link operation of an operator on the operating platform 203, and load lifting is started to dock and remove the overall hoisting structure of the reactor core 34.

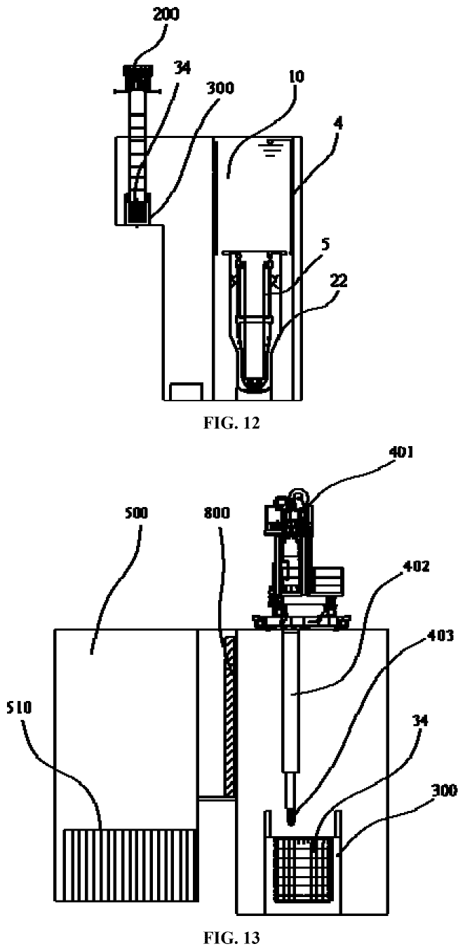

FIG. 12 is a schematic diagram of boisting out the reactor core 34 and placing the reactor core 34 on the reactor core storage rack 300 by the reactor core hoisting tool 200 according to a specific embodiment of the present invention.

As shown in FIG. 12, in step S6, after hoisting and moving the reactor core 34 as a whole out of the integrated reactor 100, the reactor core hoisting tool 200 places the reactor core 34 on the reactor core storage rack 300. When lifting the reactor core 34, the refueling water level in the reactor cavity 10 can gradually increase. After the reactor core 34 is completely hoisted out, the refueling water level also returns to the high normal water level.

FIG. 13 is a schematic diagram of refueling nuclear fuel assemblies by the refueling machine 400 according to a specific embodiment of the present invention.

As shown in FIG. 13, in step S7, the nuclear fuel assemblies in the reactor core 34 are refueled by using the refueling machine 400. The bridge crane 401 drives the telescopic sleeve 402 to move above the reactor core storage rack 300, and then the special operating gripper 403 on the telescopic sleeve 402 is used to grab the nuclear fuel assembly in the reactor core 34 and move it to the spent fuel storage grid rack 510 in the spent fuel pool for replacement.

In the integrated reactor charging and refueling method of the present invention, the simplified and optimized system structure brought about by adopting the integrated cover opening, overall core hoisting and out-of-reactor refueling is beneficial to modularize the arrangement of compact reactors such as integrated reactors, which facilitates the realization of overall arrangements of single reactors, dual reactors or multiple reactors, and improves the technical flexibility of integrated reactors in site applications. By adopting the overall reactor core hoisting and out-of-reactor refueling, compared with the existing pressurized water reactor refueling technology, the operation on fuel assemblies can be separated from the critical path for refueling and can be carried out simultaneously with the further disassembly of the reactor, thereby shortening the overhaul path and improving the economics of operation and maintenance of power plants.

The above are only preferred embodiments of the present application, and are not intended to limit the present application. For those skilled in the art, the present application may have various modifications and changes. Any modifications, equivalent replacements, improvements, etc. made within the essence and principles of this application shall be included within the protection scope of this application.

1. An integrated reactor, comprising:
a reactor cavity;
a containment, which is arranged in the reactor cavity, wherein the containment comprises an upper containment and a lower containment, and the upper containment and the lower containment are detachably and fixedly connected; and
a pressure vessel, which is arranged in the containment, wherein the pressure vessel comprises an upper pressure vessel and a lower pressure vessel, and the upper pressure vessel and the lower pressure vessel are detachably and fixedly connected,
wherein the upper pressure vessel and the upper containment are fixedly connected to form an integrated hoisting structure.

2. The integrated reactor according to claim 1, wherein the pressure vessel is provided with reactor internals therein, and the reactor internals comprise a control rod driving mechanism, an upper in-reactor component, an in-reactor measurement grid, and a reactor core provided with a nuclear fuel assembly therein,
the reactor core is arranged in the lower pressure vessel and is provided with a reactor core hoisting structure for hoisting the reactor core; and
the in-reactor measurement grid is connected to the upper in-reactor component, the upper in-reactor component is connected to the control rod driving mechanism, and the control rod driving mechanism and the upper in-reactor component are connected into one piece with the upper pressure vessel.

3. The integrated reactor according to claim 2, wherein an out-of-reactor guide device is provided outside the containment, and the out-of-reactor guide device is configured to provide hoisting guidance for the reactor core passing a position of the upper pressure vessel when the reactor core is hoisted.

4. The integrated reactor according to claim 1, wherein an in-reactor guide device is provided in the lower pressure vessel, and the in-reactor guide device is configured to provide hoisting guidance for the reactor core in the lower pressure vessel when the reactor core is hoisted.

5. An integrated reactor charging and refueling system, comprising a reactor core hoisting tool and the integrated reactor according to claim 1,
wherein during charging and refueling of the integrated reactor, after the integrated hoisting structure is hoisted and removed as a whole, the reactor core hoisting tool is able to enter an interior of the lower pressure vessel to be connected with the reactor core hoisting structure, so as to hoist and remove the reactor core as a whole.

6. The integrated reactor charging and refueling system according to claim 5, wherein the reactor core hoisting tool has a first guide part, and the first guide part is configured to cooperate with the out-of-reactor guide device for guiding the movement of the reactor core hoisting tool at the position of the upper pressure vessel.

7. The integrated reactor charging and refueling system according to claim 6, wherein the reactor core hoisting tool has a second guide part, and the second guide part is configured to cooperate with the in-reactor guide device for guiding the movement of the reactor core hoisting tool in the lower pressure vessel.

8. The integrated reactor charging and refueling system according to claim 5, further comprising a reactor core storage rack, a refueling machine, a spent fuel pool and a refueling pool, wherein the reactor core storage rack is located in the refueling pool, the reactor core hoisted out of the lower pressure vessel by the reactor core hoisting tool is to be arranged in the reactor core storage rack, and the refueling machine is configured to take the nuclear fuel assembly out of the reactor core to the spent fuel pool for refueling.

9. The integrated reactor charging and refueling system according to claim 8, further comprising a reactor cavity water gate for isolating the reactor cavity from the refueling pool, and for controlling a refueling water level in the reactor cavity.

10. The integrated reactor charging and refueling system according to claim 8, further comprising a spent pool water gate for isolating the refueling pool from the spent fuel pool.

11. The integrated reactor charging and refueling system according to claim 8, further comprising an integrated hoisting structure storage rack disposed in the refueling pool for placing the removed integrated hoisting structure.

12. An integrated reactor charging and refueling method, which is implemented by using the integrated reactor charging and refueling system according to claim 5, the method comprising the following steps of:
hoisting and removing the integrated hoisting structure as a whole;
moving the reactor core hoisting tool above the integrated reactor;
enabling the first guide part of the reactor core hoisting tool to cooperate with the out-of-reactor guide device to guide slow lowering of the reactor core hoisting tool at the position of the upper pressure vessel;
enabling the second guide part of the reactor core hoisting tool to cooperate with the in-reactor guide device to guide slow lowering of the reactor core hoisting tool at a position of the lower pressure vessel;
connecting the reactor core hoisting tool with the reactor core hoisting structure;
enabling the reactor core hoisting tool to drive the reactor core to move out of the integrated reactor; and
refueling the nuclear fuel assembly in the reactor core by using the refueling machine.
